(19) United States
(12) Patent Application Publication
(10) Pub. No.: US 2019/0104130 A1
(43) Pub. Date: Apr. 4, 2019

(54) APPARATUS AND METHOD FOR CONTROLLING NETWORK ACCESS

(71) Applicant: SAMSUNG SDS CO., LTD., Seoul (KR)

(72) Inventors: Byung-Hyun CHO, Seoul (KR); Kyung-Choon MIN, Seoul (KR); Gyu-Sung MOON, Seoul (KR); Seon-Ok PARK, Seoul (KR); Chol CHOI, Seoul (KR); Jun-Won LEE, Seoul (KR); Do-Youn KIM, Seoul (KR)

(73) Assignee: SAMSUNG SDS CO., LTD., Seoul (KR)

(21) Appl. No.: 16/134,394

(22) Filed: Sep. 18, 2018

(30) Foreign Application Priority Data
Sep. 29, 2017 (KR) 10-2017-0127276

(51) Int. Cl. H04L 29/06

(52) U.S. Cl. CPC H04L 63/102; H04L 63/0209; H04L 63/108; H04L 63/0892; H04L 63/083; H04L 63/0884

(57) ABSTRACT

An apparatus and method for controlling network access are provided. The apparatus for controlling network access includes an authentication information acquirer configured to receive user authentication information from one or more terminals, an extensible authentication protocol (EAP) host creator configured to create one or more virtual EAP hosts for the one or more terminals, each of the one or more virtual EAP hosts performing authentication in association with an authentication system through an EAP using the received user authentication information, an authenticator configured to relay messages exchanged for the authentication between each of the one or more EAP hosts and the authentication system through the EAP and an authentication, authorization, accounting (AAA) protocol and receive an authentication result and right control information from the authentication system, and a controller configured to control network access and right for each of the one or more terminals according to the received authentication result and right control information.

### CROSS-REFERENCE TO RELATED APPLICATION(S)

This application claims the benefit under 35 USC §119(a) of Korean Patent Application No. 10-2017-0127276, filed on Sep. 29, 2017, in the Korean Intellectual Property Office, the entire disclosure of which is incorporated herein by reference for all purposes.

### BACKGROUND

### 1. Field

The following description relates to a network access control technology.

### 2. Description of Related Art

With the recent depletion of IPv4 addresses, the transition to the IPv6 address system is rapidly in progress. Since the IPv4 is 32 bits whereas the IPv6 is 128 bits, requiring the use of Dynamic Host Configuration Protocol (DHCP), an Internet protocol (IP) address-based network use process is required to be switched to a user ID-based network use process.

Extensible Authentication Protocol (EAP) technology is used to identify a user identity of a terminal attempting to access the network, and 802.1x technology including EAP technology is used in a LAN network. However, in the case of a wired network, it is difficult to apply such technologies in reality due to the following problems and hence the introduction thereof is not actively carried out.

1) Terminal environment difficult to apply 802.1x/EAP

Most terminal operating systems (OSs) require separate 802.1x authentication settings for the wired network. In order to solve this problem, most of the terminal OSs distribute a separate program to help access the network.

2) Network environment difficult to apply 802.1x/EAP

802.1x technology is applied to L2 switches that are directly connected to a terminal. Since L2 switches are required in large quantity and have simple functions, inexpensive products are generally used. However, some L2 switches may not support 802.1x, or there may be a difference in level of support by each vendor and/or each model, and thus replacement/introduction of L2 switches may be required. In addition, in operating a network, 802.1x should be set on the basis of ports of L2 switches and be applied and the operation range and the level of difficulty are increased since each switch is associated with the authentication system.

3) Limited network control solution features

The existing network control solution identifies and controls terminals using mainly a unique media access control (MAC) address of a network interface of each of the terminals rather than a user ID. Although user authentication may be supported, even in such a case, account information (ID/password) is only checked in the authentication system at the time of initial access and the password is transmitted in plaintext or encrypted at a low level according to the technology associated with the authentication system, so that there is a risk of exposure.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide an apparatus and method for controlling network access.

In one general aspect, there is provided an apparatus for controlling network access, including an authentication information acquirer configured to receive user authentication information from one or more terminals, an extensible authentication protocol (EAP) host creator configured to create one or more virtual EAP host for the one or more terminals, each of the virtual EAP hosts performing authentication in association with an authentication system through an EAP using the received user authentication information, an authenticator configured to relay messages exchanged for the authentication between each of the one or more EAP hosts and the authentication system through the EAP and an authentication, authorization, accounting (AAA) protocol and receive an authentication result and right control information from the authentication system, and a controller configured to control network access and right for each of the one or more terminals according to the received authentication result and right control information.

The AAA protocol may be one of Remote Authentication Dial-In User Service (RADIUS) protocol, DIAMETER protocol, Terminal Access Controller Access Control System (TACACS) protocol, and TACACS+ protocol.

The authenticator may encapsulate an EAP message received from each of the one or more virtual EAP hosts into an AAA protocol message, transmit the encapsulated message to the authentication system, decapsulate an AAA protocol message for each of the one or more virtual EAP hosts, which are received from the authentication system, into an EAP message and transmit the decapsulated message to each of the one or more virtual EAP hosts.

The user authentication information may include a user ID and a password.

The apparatus may further include an additional information collector configured to collect additional information usable in determining a network access right for each of the one or more terminals, wherein the authenticator transmits the additional information to the authentication system.

The EAP host creator may set a validity period for each of the one or more virtual EAP hosts.

Each of the one or more virtual EAP hosts may perform re-authentication in association with the authentication system when the validity period has expired, the authenticator may relay messages exchanged for the re-authentication between each of the one or more virtual EAP hosts and the authentication system through the EAP and the AAA protocol and receive a re-authentication result and right control information from the authentication system, and the controller may control network access for each of the one or more terminals according to the re-authentication result and the right control information.

In another general aspect, there is provided a method of controlling network access, including receiving user authentication information from one or more terminals, creating one or more virtual extensible authentication protocol (EAP) hosts for the one or more terminals, each of the one or more virtual EAP hosts performing authentication in association with an authentication system through an EAP using the received user authentication information, relaying messages exchanged for the authentication between each of the one or more EAP hosts and the authentication system through the EAP and an authentication, authorization, accounting (AAA) protocol and receiving an authentication result and right control information from the authentication system, and controlling network access and right for each of the one or more terminals according to the received authentication result and right control information.

The AAA protocol may be one of Remote Authentication Dial-In User Service (RADIUS) protocol, DIAMETER protocol, Terminal Access Controller Access Control System (TACACS) protocol, and TACACS+ protocol.

The relaying may include encapsulating an EAP message received from each of the one or more virtual EAP hosts into an AAA protocol message, transmitting the encapsulated message to the authentication system, decapsulating an AAA protocol message for each of the one or more virtual EAP hosts, which are received from the authentication system, into an EAP message, and transmitting the decapsulated message to each of the one or more virtual EAP hosts.

The user authentication information may include a user ID and a password.

The method may further include collecting additional information usable in determining a network access right for each of the one or more terminals, wherein the relaying comprises transmitting the additional information to the authentication system.

The creating of the one or more virtual EAP hosts may include setting a validity period for each of the one or more virtual EAP hosts.

The method may further include relaying messages exchanged for re-authentication between each of the one or more virtual EAP hosts and the authentication system through the EAP and the AAA protocol, when the validity period has expired, receiving a re-authentication result and right control information from the authentication system, and controlling network access for each of the one or more terminals according to the re-authentication result and the right control information.

Other features and aspects will be apparent from the following detailed description, the drawings, and the claims.

### BRIEF DESCRIPTION OF THE DRAWINGS

FIG. 1 is a diagram illustrating an example of a network access control system applied to embodiments of the present disclosure.

FIG. 2 is a diagram illustrating a configuration of an apparatus for controlling network access according to one embodiment of the present disclosure.

FIG. 3 is a diagram illustrating a configuration of an apparatus for controlling network access according to additional embodiment of the present disclosure.

FIG. 4 is a flowchart illustrating an example of a network access control process according to one embodiment of the present disclosure.

FIG. 5 is a flowchart illustrating an example of a network access control process according to an additional embodiment of the present disclosure.

FIG. 6 is a flowchart illustrating an example of re-authentication and network access control process according to one embodiment of the present disclosure.

FIG. 7 is a block diagram for describing an example of a computing environment including a computing device suitable to be used in illustrative embodiments of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

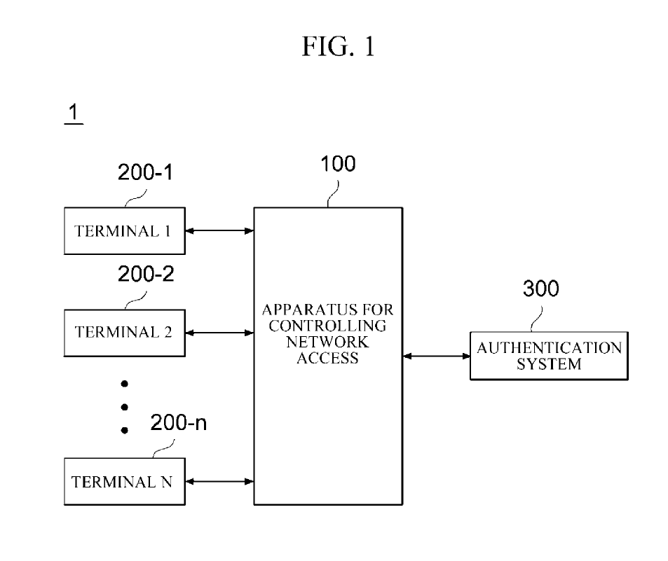

FIG. 1 is a diagram illustrating an example of a network access control system applied to embodiments of the present disclosure.

Referring to FIG. 1, the network access control system 1 according to one embodiment of the present disclosure includes an apparatus 100 for controlling network access, one or more terminals 200-1, 200-1, and 200-n, and an authentication system 300.

The apparatus 100 for controlling network access controls network access of each of the one or more terminals 200-1, 200-2, and 200-n. Specifically, according to one embodiment of the present disclosure, the apparatus 100 may perform authentication of a user of each of the terminals 200-1, 200-2, and 200-n through an extensible authentication protocol (EAP) and may control network access and a network access right of each of the terminals 200-1, 200-2, and 200-n according to the authentication result.

To this end, according to one embodiment of the present disclosure, the apparatus 100 creates a virtual EAP host for each of the terminals 200-1, 200-2, and 200-n and performs authentication of the user of each of the terminals 200-1, 200-2, and 200-n in association with the authentication system 300 using the virtual EAP host created for each terminal.

Meanwhile, the one or more terminals 200-1, 200-2, and 200-n may include, for example, a desktop computer, a notebook computer, a tablet computer, a smartphone, a personal digital assistant (PDA), and the like. However, each of the terminals 200-1, 200-2, and 200-n is not necessarily limited to the above examples and may include various forms of devices capable of accessing a network through a wired/wireless communication function.

The authentication system 300, which is provided for determining whether to allow each of the terminals 200-1, 200-2, and 200-n to access a network and determining a network access right of each terminal 200-1, 200-2, and 200-n through user authentication, may include one or more servers which perform authentication of a user of each of the terminals 200-1, 200-2, and 200-n through an authentication, authorization, accounting (AAA) protocol, such as Remote Authentication Dial-In User Service (RADIUS) protocol, Diameter protocol, Terminal Access Controller Access Control System (TACACS) protocol, TACACS+ protocol, and the like.

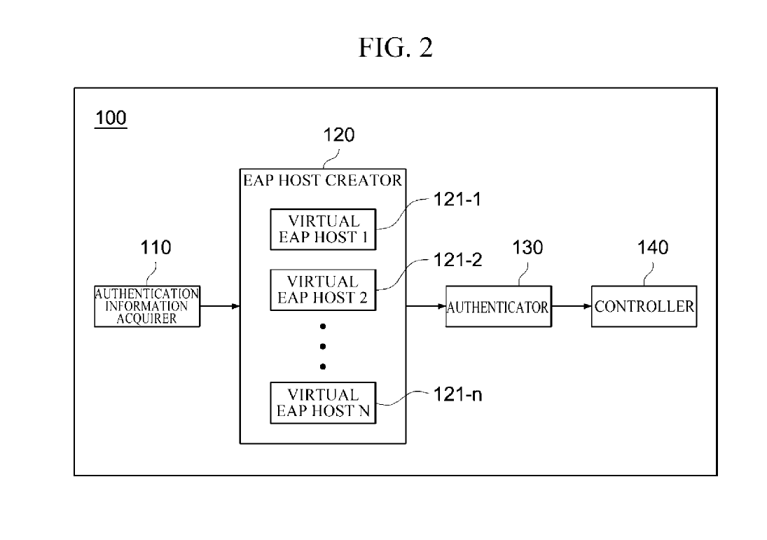

FIG. 2 is a diagram illustrating a configuration of an apparatus for controlling network access according to one embodiment of the present disclosure.

Referring to FIG. 2, the apparatus 100 for controlling network access includes authentication information acquirer 110, an EAP host creator 120, an authenticator 130, and a controller 140.

The authentication information acquirer 110 requests each of terminals 200-1, 200-2, and 200-n for user authentication information and receives the user authentication information from each terminal 200-1, 200-2, and 200-n. In this case, the user authentication information may include, for example, a user ID and a password.

The EAP host creator 120 creates a virtual EAP host 121-1, 121-2, and 121-n for each of the terminals 200-1, 200-2, and 200-n which have transmitted the user authentication information. For example, the EAP host creator 120 may receive the user authentication information of each terminal 200-1, 200-2, and 200-n and a virtual EAP host creation command for each terminal 200-1, 200-2, and 200-n from the authentication information acquirer 110. When creation of a virtual EAP host is requested, the EAP host creator 120 may create a virtual EAP host for each of the terminals 200-1, 200-2, and 200-n and transmit the user authentication information to the created virtual EAP hosts 121-1, 121-2, and 121-n.

Meanwhile, each of the virtual EAP hosts 121-1, 121-2, and 121-n may perform authentication of a user of each of the terminals 200-1, 200-2, and 200-n in association with an authentication system 300 using the user authentication information transmitted from the authentication information acquirer 110. In this case, the authentication method through EAP may include, for example, Protected EAP (PEAP), EAP-Transport Layer Security (EAP-TLS), EAP-Tunneled Transport Layer Security (EAP-TTLS), lightweight EAP (LEAP), EAP-Flexible Authentication via Secure Tunneling (EAP-FAST), EAP-Message Digest 5 (EAP-MD5), and the like.

The authenticator 130 relays messages exchanged for the user authentication between each of the virtual EAP hosts 121-1, 121-2, and 121-n and the authentication system 300 through the EAP and AAA protocol and receives the authentication result and right control information from the authentication system 300. In this case, the right control information may include a variety of information required for controlling a network access right for each of the terminals 200-1, 200-2, and 200-n, such as a role assigned to a user for role based access control, an access control list (ACL), a virtual local area network (VLAN) information, redirect uniform resource locator (URL) address, a valid period of a session, an instruction message, and the like.

Specifically, the authenticator 130 may communicate with each of the virtual EAP hosts 121-1, 121-2, and 121-n through the EAP, communicate with the authentication system 300 through the AAA protocol, and relay messages exchanged for the user authentication between each of the virtual EAP hosts 121-1, 121-2, and 121-n and the authentication system 300. In this case, the AAA protocol may be one of, for example, a RADIUS protocol, a DIAMETER protocol, a TACACS protocol, and a TACACS+ protocol.

More specifically, the authenticator 130 may encapsulate EAP messages received from the respective virtual EAP hosts 121-1, 121-2, and 121-n into AAA protocol messages and transmit the encapsulated messages to the authentication system 300. In addition, the authenticator 130 may decapsulate the AAA protocol messages for each of the virtual EAP hosts 121-1, 121-2, 121-n, which are received from the authentication system 300, into EAP messages and transmit the decapsulated messages to the respective virtual EAP hosts 121-1, 121-2, 121-n.

Meanwhile, the messages exchanged for the user authentication between each of the virtual EAP hosts 121-1, 121-2, and 121-n and the authentication system 300 may vary according to the EAP authentication scheme (e.g., PEAP, EAP-TLS, EAP-TTLS, LEAP, EAP-FAST, EAP-MD5, etc.) used in authentication.

According to one embodiment of the present disclosure, when the authentication result and the right control information for each of the terminals 200-1, 200-2, and 200-n is received from the authentication system 300, the authenticator 130 may transmit the received authentication result and right control information to the controller 140 to request network access and right control for each of the terminals 200-1, 200-2, and 200-n.

The controller 140 controls the network access and right for each of the terminals 200-1, 200-2, and 200-n according to the received authentication result and access right control information.

For example, when the authentication system 300 fails to authenticate the user of terminal 1 200-1, the authentication system 300 may transmit an authentication result indicating a failure of the authentication for the user of terminal 1 200-1 to the authenticator 130. In this case, the controller 140 may receive the authentication result from the authenticator 130 and control network devices (e.g., a switch, a router, an access point (AP), etc.) to prevent terminal 1 200-1 from accessing the network.

In another example, when the authentication system 300 successfully authenticates the user of terminal 1 200-1, the authentication system 300 may transmit an authentication result indicating the successful authentication of the user of terminal 1 200-1 and right control information including network VLAN information to be allocated to terminal 1 200-1 in accordance with a group (e.g., employees, visitors, and the like) to which the user of terminal 1 200-1 belongs to the authenticator 130. In this case, the controller 140 may receive the authentication result and the right control information from the authenticator 130 and transmit the network VLAN information of terminal 1 200-1 to the network devices.

In another example, when the authentication system 300 successfully authenticates a user of terminal 2 200-2 but a password change cycle for a user's account has passed, the authentication system 300 may transmit right control information including a redirect URL address for automatically connecting to a password change page and an ACL allowing an access only to the corresponding page and an authentication result indicating the successful authentication of the user of terminal 2 200-2 to the authenticator 130. In this case, the controller 140 may receive the authentication result and the right control information from the authenticator 130 and transmit the redirect URL address and the ACL to terminal 2 200-2 and the network devices, thereby controlling terminal 2 200-2 to access only to the password change page.

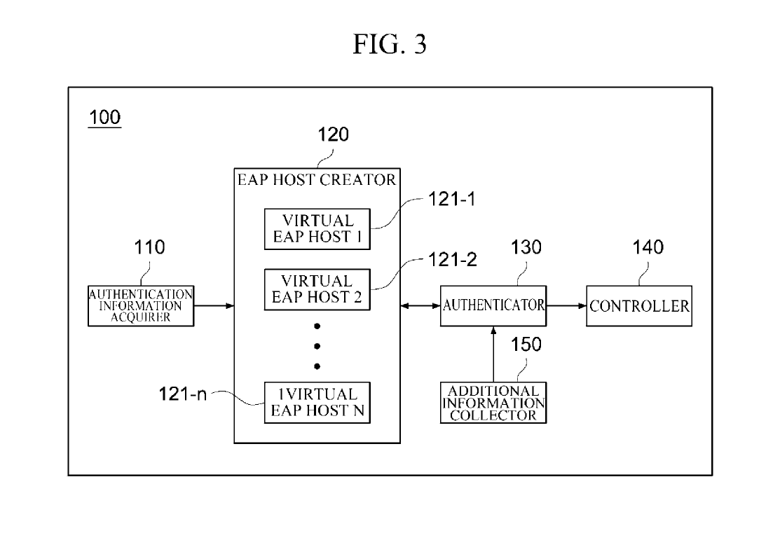

FIG. 3 is a diagram illustrating a configuration of an apparatus for controlling network access according to additional embodiment of the present disclosure.

Referring to FIG. 3, the apparatus 100 for controlling network access according to additional embodiment of the present disclosure may further include an additional information collector 150.

The additional information collector 150 collects additional information usable for determining a network access right for each of the terminals 200-1, 200-2, and 200-n and transmits the collected information to the authenticator 130.

In this case, the additional information may include, for example, a media access control (MAC) address of each terminal 200-1, 200-2, and 200-n, a type of operating system (OS) and patch information, vaccine information, Internet protocol (IP) addresses of network devices (e.g., a switch, an AP, and so on) included in a network to be accessed by each terminal 200-1, 200-2, and 200-n, and the like. However, the additional information is not necessarily limited to the above examples and may include various types of information which can be collected from each terminal 200-1, 200-2, and 200-n, programs installed in each terminal 200-1, 200-2, and 200-n, and a network to be accessed by each terminal 200-1, 200-2, and 200-n and can be utilized when the authentication system 300 determines the network access right.

Meanwhile, the authenticator 130 may add the additional information transmitted from the additional information collector 150 to EAP messages received from the virtual EAP hosts 121-1, 121-2, and 121-n and transmit the EAP messages to the authentication system 300. Thereafter, the authenticator 130 may receive an authentication result and right control information for each terminal 200-1, 200-2, and 200-n from the authentication system 300 and transmit the received result and information to the controller 140.

Accordingly, the authentication system 300 may be able to use various types of information included in the additional information, as well as the authentication information for the users, in determining a network access right for each of the terminals 200-1, 200-2, and 200-n, thereby being capable of performing more precise right control.

For example, when employee A attempts to access an corporate network using a personal PC instead of a business PC whose MAC address is registered, the authentication system 300 may generate right control information to prevent the personal PC from accessing the network and transmit the right control information to the authenticator 130 since a MAC address of the personal PC transmitted by the authenticator 130 as additional information has not been registered even when user authentication succeeds using user authentication information of employee A. Accordingly, the controller 140 may receive the right control information from the authenticator 130 and control the access of the personal PC to the corporate network to be prevented.

In another example, when employee A who works at business location A of a specific company visits business location B of the same company and attempts to access a network of business location B using a business PC provided in business location B, the authentication system 300 may transmit right control information including VLAN information of a network for business visitors to be assigned to the corresponding business PC on the basis of a MAC address of the business PC, an IP address of a network device at business location B, and authentication information of employee A, which are transmitted by the authenticator 130, to the authenticator 130. Accordingly, the controller 140 may receive the right control information from the authenticator 130 and control employee A to be allowed to access the network for business visitors at business location B.

Meanwhile, according to one embodiment of the present disclosure, the EAP host creator 120 may set a validity period for each of the virtual EAP hosts 121-1, 121-2, and 121-n when creating the virtual EAP hosts 121-1, 121-2, and 121-n for each of the terminals 200-1, 200-2, and 200-n.

In this case, when the set validity period has expired, each of the EAP hosts 121-1, 121-2, and 121-n may perform re-authentication for the users of the respective terminals 200-1, 200-2, and 200-n in association with the authentication system 300 through the EAP using the user authentication information of each of the terminals 200-1, 200-2, and 200-n which have been transmitted from the authentication information acquirer 110 in the initial authentication process.

In this case, the authenticator 130 may relay messages exchanged for the re-authentication between each of the virtual EAP hosts 121-1, 121-2, and 121-n and the authentication system 300 through the EAP and the AAA protocol and receive an authentication result and right control information from the authentication system 300. In addition, according to one embodiment, the authenticator 130 may add the additional information, which is transmitted from the information collector 150, to EAP messages received for re-authentication from the virtual EAP hosts 121-1, 121-2, and 121-n and transmit the EAP message to the authentication system 300.

Meanwhile, the controller 140 may control the network access and right for each of the terminals 200-1, 200-2, and 200-n using the authentication result and right control information, which are received from the authentication system 300, through the re-authentication by the authenticator 130.

According to one embodiment, the authentication information acquirer 110, the EAP host creator 120, the virtual EAP hosts 121-1, 121-2, and 121-n, the authenticator 130, the controller 140, and the additional information collector 150, which are illustrated in FIGS. 1 and 2, may be implemented on one or more computing devices each of which includes one or more processors and a computer-readable recording medium connected to the one or more processors. The computer-readable recording medium may be present inside or outside processors and be connected to the processors by various well-known means. The processors present inside each of the computing devices may allow each computing device to operate according to exemplary embodiments described herein. For example, the processors may execute an instruction stored in the computer-readable recording medium, and the instruction stored in the computer-readable recording medium may be configured to allow the computing device to execute operations according to the exemplary embodiments described herein when executed by the processors.

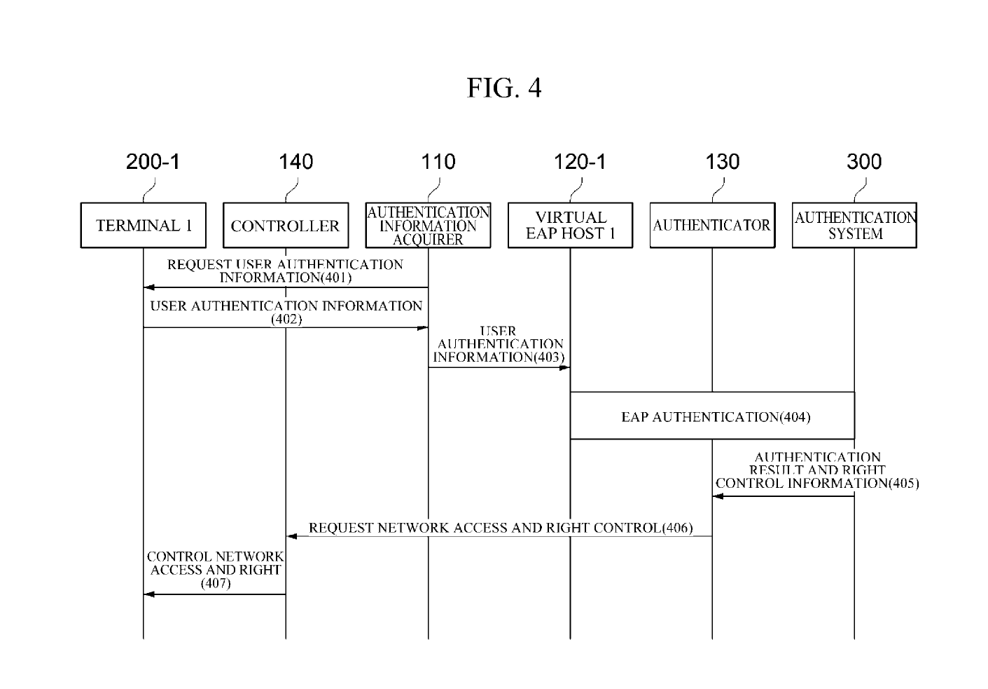

FIG. 4 is a flowchart illustrating an example of a network access control process according to one embodiment of the present disclosure.

Referring to FIG. 4, an authentication information acquirer 110 requests terminal 1 200-1 for user authentication information (401) and receives the user authentication information from terminal 1 200-1 (402).

Then, the authentication information acquirer 110 transmits the user authentication information to virtual EAP host 1 120-1 which is generated for terminal 1 200-1 by an EAP host creator 120 (403).

Then, virtual EAP host 1 120-1 performs user authentication in association with the authentication system 300 using the user authentication information (404). In this case, the authenticator 130 may relay messages exchanged for the user authentication between virtual EAP host 1 121-1 and the authentication system 300 through the EAP and the AAA protocol.

Then, the authentication system 300 transmits an authentication result and right control information to the authenticator 130 (405).

Then, the authenticator 130 transmits the authentication result and the right control information, which are transmitted from the authentication system 300, to a controller 140 to request the network access and right control for terminal 1 200-1 (406).

Then, the controller 140 controls the network access and right for terminal 1 200-1 according to the authentication result and right control information received from the authenticator 130 (407).

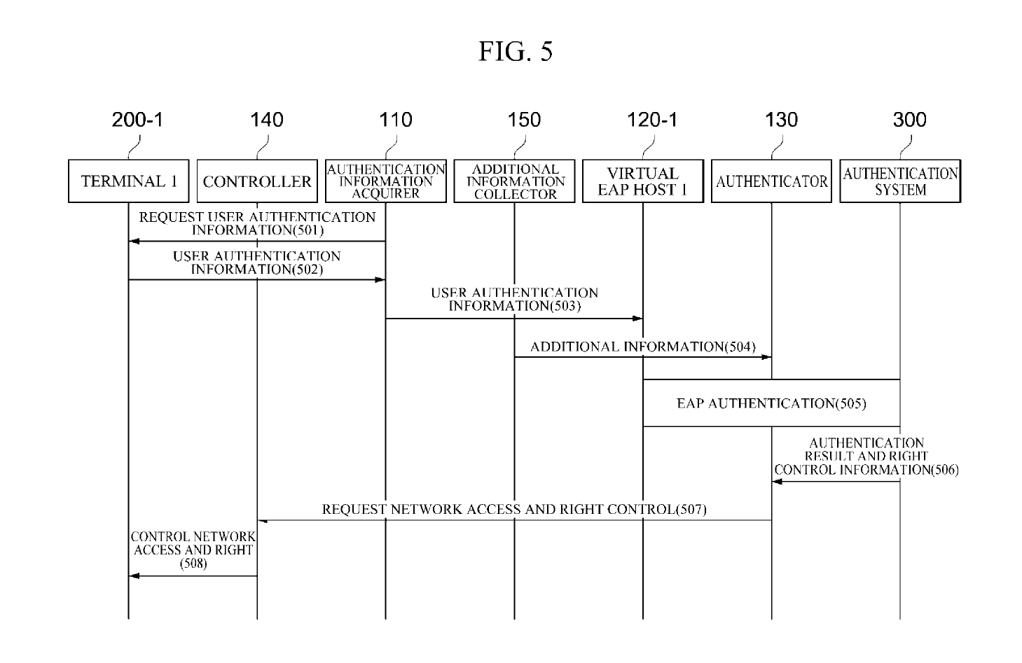

FIG. 5 is a flowchart illustrating an example of a network access control process according to an additional embodiment of the present disclosure.

Referring to FIG. 5, an authentication information acquirer 110 requests terminal 1 200-1 for user authentication information (501) and receive the user authentication information from terminal 1 200-1 (502).

Then, the authentication information acquirer 110 transmits the user authentication information to virtual EAP host 1 120-1 created for terminal 1 200-1 by an EAP host creator 120 (503).

Then, an additional information collector 150 collects additional information usable for determining a network access right and transmits the collected information to an authenticator 130 (504).

Then, virtual EAP host 1 120-1 performs user authentication in association with an authentication system 300 using user authentication information (505). In this case, the authenticator 130 may relay messages exchanged for the user authentication between virtual EAP host 1 121-1 and the authentication system 300 through an EAP and an AAA protocol, and may add the additional information to an EAP message transmitted from virtual EAP host 1 120-1 and transmit the EAP message to the authentication system 300.

Then, the authentication system 300 transmits the authentication result and right control information to the authenticator 130 (506).

Then, the authenticator 130 transmits the authentication result and the right control information, which have been transmitted from the authentication system 300, to the controller 140 and requests the controller 140 for network access and right control for terminal 1 200-1 (507).

Then, the controller 140 controls the network access and right for terminal 1 200-1 according to the authentication result and right control information transmitted from the authenticator 140 (507).

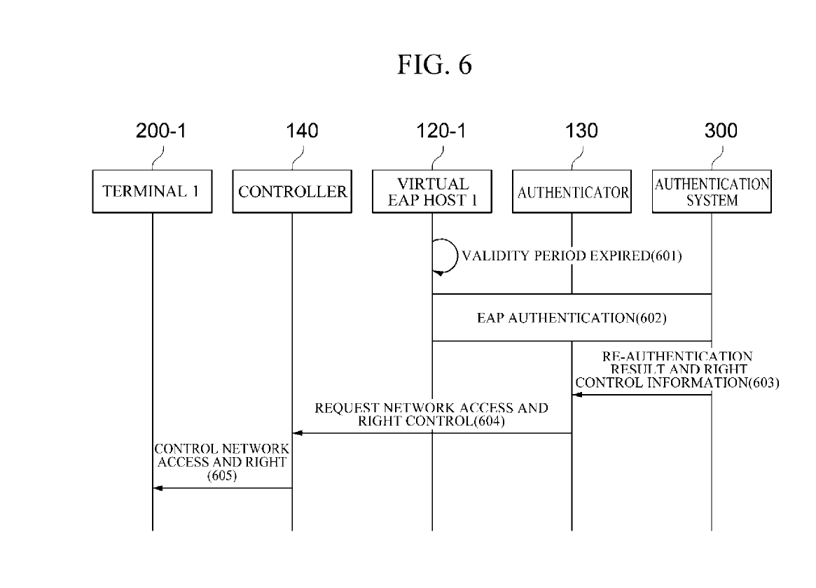

FIG. 6 is a flowchart illustrating an example of re-authentication and network access control process according to one embodiment of the present disclosure.

Referring to FIG. 6, when a validity period set in virtual EAP host 1 120-1 has expired (601), virtual EAP host 1 120-1 performs re-authentication for a user of terminal 1 200-1 in association with an authentication system 300 using user authentication information of terminal 1 200-1 (602). In this case, virtual EAP host 1 120-1 may use, for example, user authentication information which was transmitted from the authentication information acquirer 110 in the initial authentication process, which is illustrated in FIG. 4 or 5.

Meanwhile, the authenticator 130 may relay messages exchanged for the re-authentication between virtual EAP host 1 121-1 and the authentication system 300 through the EAP and the AAA protocol. In this case, according to one embodiment, the authenticator 130 may add additional information collected by an additional information collector 150 to an EAP message transmitted from virtual EAP host 1 120-1 and transmit the EAP message to the authentication system 300.

Then, the authentication system 300 transmits an authentication result and right control information to the authenticator 130 (603).

Then, the authenticator 130 transmits the authentication result and the right control information, which are transmitted from the authentication system 300, to the controller 140 to request the network access and right control for terminal 1 200-1 (604).

Thereafter, the controller 140 controls the network access and right for terminal 1 200-1 according to the authentication result and right control information transmitted from the authenticator 140 (605).

Meanwhile, in the flowcharts illustrated FIGS. 4 to 6, the network access control process is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

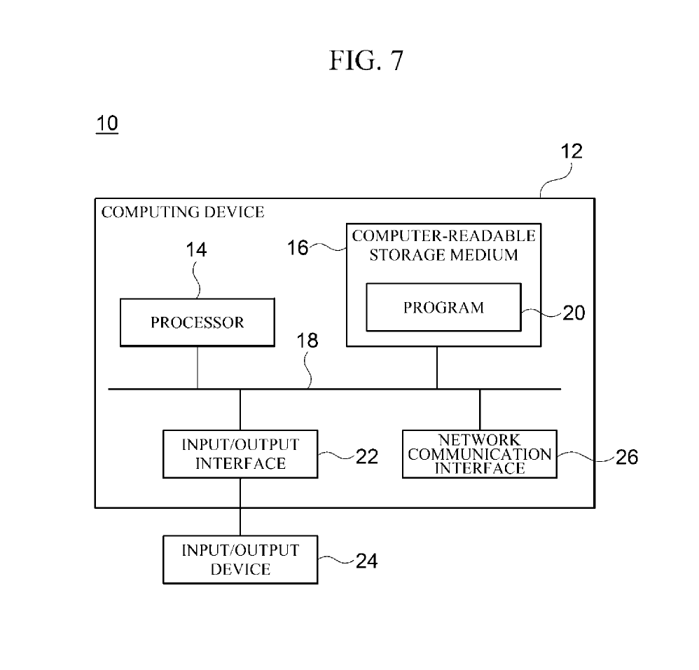

FIG. 7 is a block diagram for describing an example of a computing environment including a computing device suitable to be used in illustrative embodiments of the present disclosure. In the illustrate embodiment, each of the components may have functions and capabilities different from those described hereinafter and additional components may be included in addition to the components described herein.

The illustrated computing environment 10 includes a computing device 12. In one embodiment, the computing device 12 may be one or more components included in the network access control apparatus 100, such as the authentication information acquirer 110, the EAP host creator 120, the virtual EAP hosts 121-1, 121-2, and 121-n, the authenticator 130, the controller 140, and the additional information collector 150, which are illustrated in FIGS. 2 and 3.

The computing device 12 includes at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to the illustrative embodiment.

The computer readable storage medium 16 is configured to store computer executable commands and program codes, program data and/or information in other suitable forms. The programs stored in the computer readable storage medium 16 may include a set of commands executable by the processor 14. In one embodiment, the computer readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

According to the embodiments of the present disclosure, functions performed in each terminal and a network device for authentication through the EAP are allowed to be performed on a network access control apparatus through virtual EAP hosts for each terminal, and thereby EAP authentication is possible without change in terminals and network environment.

In addition, according to the embodiments of the present invention, at the time of EAP authentication, additional information usable in determining a network access right for each terminal is transmitted to an authentication system, so that more various types of information can be taken into account in determining the network access right for each terminal and accordingly more prices network access right control is possible.

Further, according to the embodiments of the present disclosure, a validity period is set for a virtual EAP host for each terminal and re-authentication is performed when the validity period has expired, and thereby an event of change in user's right can be reflected.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling network access, comprising:
an authentication information acquirer configured to receive user authentication information from one or more terminals;
an extensible authentication protocol (EAP) host creator configured to create one or more virtual EAP hosts for the one or more terminals, each of the one or more virtual EAP hosts performing authentication in association with an authentication system through an EAP using the received user authentication information;
an authenticator configured to relay messages exchanged for the authentication between each of the one or more EAP hosts and the authentication system through the EAP and an authentication, authorization, accounting (AAA) protocol and receive an authentication result and right control information from the authentication system; and
a controller configured to control network access and right for each of the one or more terminals according to the received authentication result and right control information.

2. The apparatus of claim 1, wherein the AAA protocol is one of Remote Authentication Dial-In User Service (RADIUS) protocol, DIAMETER protocol, Terminal Access Controller Access Control System (TACACS) protocol, and TACACS+ protocol.

3. The apparatus of claim 1, wherein the authenticator encapsulates an EAP message received from each of the one or more virtual EAP hosts into an AAA protocol message, transmits the encapsulated message to the authentication system, decapsulates an AAA protocol message for each of the one or more virtual EAP hosts, which are received from the authentication system, into an EAP message and transmits the decapsulated message to each of the one or more virtual EAP hosts.

4. The apparatus of claim 1, wherein the user authentication information includes a user ID and a password.

5. The apparatus of claim 1, further comprising an additional information collector configured to collect additional information usable in determining a network access right for each of the one or more terminals,
wherein the authenticator transmits the additional information to the authentication system.

6. The apparatus of claim 1, wherein the EAP host creator sets a validity period for each of the one or more virtual EAP hosts.

7. The apparatus of claim 6, wherein each of the one or more virtual EAP hosts performs re-authentication in association with the authentication system when the validity period has expired,
the authenticator relays messages exchanged for the re-authentication between each of the one or more virtual EAP hosts and the authentication system through the EAP and the AAA protocol and receives a re-authentication result and right control information from the authentication system, and
the controller controls network access for each of the one or more terminals according to the re-authentication result and the right control information.

8. A method of controlling network access, comprising:
receiving user authentication information from one or more terminals;
creating one or more virtual extensible authentication protocol (EAP) hosts for the one or more terminals, each of the one or more virtual EAP hosts performing authentication in association with an authentication system through an EAP using the received user authentication information;
relaying messages exchanged for the authentication between each of the one or more EAP hosts and the authentication system through the EAP and an authentication, authorization, accounting (AAA) protocol;
receiving an authentication result and right control information from the authentication system; and
controlling network access and right for each of the one or more terminals according to the received authentication result and right control information.

9. The method of claim 8, wherein the AAA protocol is one of Remote Authentication Dial-In User Service (RADIUS) protocol, DIAMETER protocol, Terminal Access Controller Access Control System (TACACS) protocol, and TACACS+ protocol.

10. The method of claim 8, wherein the relaying comprises:
encapsulating an EAP message received from each of the one or more virtual EAP hosts into an AAA protocol message;
transmitting the encapsulated message to the authentication system;
decapsulating an AAA protocol message for each of the one or more virtual EAP hosts, which are received from the authentication system, into an EAP message; and
transmitting the decapsulated message to each of the one or more virtual EAP hosts.

11. The method of claim 8, wherein the user authentication information includes a user ID and a password.

12. The method of claim 8, further comprising collecting additional information usable in determining a network access right for each of the one or more terminals,
wherein the relaying comprises transmitting the additional information to the authentication system.

13. The method of claim 8, wherein the creating of the one or more virtual EAP hosts comprises setting a validity period for each of the one or more virtual EAP hosts.

14. The method of claim 13, further comprising:
relaying messages exchanged for re-authentication between each of the one or more virtual EAP hosts and the authentication system through the EAP and the AAA protocol, when the validity period has expired;
receiving a re-authentication result and right control information from the authentication system; and
controlling network access for each of the one or more terminals according to the re-authentication result and the right control information.
